(19) United States
(12) Patent Application Publication
(10) Pub. No.: US 2016/0338329 A1
(43) Pub. Date: Nov. 24, 2016

(54) Bladed fishing lure assembly

(71) Applicant: David L. Thorne, Kaysville, UT (US)

(72) Inventor: David L. Thorne, Kaysville, UT (US)

(21) Appl. No.: 14/545,547

(22) Filed: May 19, 2015

(51) Int. Cl. A01K 85/18; A01K 85/02; A01K 85/00

(52) U.S. Cl. CPC A01K 85/18; A01K 85/00; A01K 85/02

(57) ABSTRACT

An inline bladed weighted fishing lure is disclosed in which the blade is designed to oscillate side-to-side during retrieval and is loosely, but securely affixed to a frame. The frame includes an inferior portion that is securely connected to a weighted body and also includes features for attachment of a fishing line and facile blade assembly. The attachment feature, weight and rearward parts of the lure being disposed substatially inline to provide assurance against bending forces which would otherwise tend to detune lure operation.

### CONTINUITY

This application is a Continuation-in-Part of U.S. patent application Ser. No. 14/544,787, titled FRAMES FOR BLADED AND WEIGHTED FISHING LURES and filed Feb. 18, 2015; which is a Continuation-in-Part of U.S. patent application Ser. No. 14/120,871, titled BLADED FISHING LURE and filed on Jul. 7, 2014; which is a Continuation-in-Part of patent application Ser. No. 13/999,599 titled LURE FISHING ASSEMBLY WITH WEIGHTED FRAME and filed Mar. 5, 2014; which is a Continuation of patent application Ser. No. 13/694,028, titled LURE FISHING ASSEMBLY WITH WEIGHTED FRAME and filed Oct. 22, 2012, now allowed as U.S. Pat. No. 8,733,012; which is a Continuation-in-Part of U.S. patent application Ser. No. 13/200,900, titled INTERCHANGEABLE BLADE AND LURE FISHING ASSEMBLY and filed Oct. 4, 2011, now allowed as U.S. Pat. No. 8,739,460; which is a Continuation-in-Part of U.S. patent application Ser. No. 12/387,024 titled BLADED FISHING LURE ASSEMBLY and filed Apr. 27, 2009, now allowed as U.S. Pat. No. 8,973,298; which is a Continuation-in-Part of U.S. patent application Ser. No. 11/656,099, titled FISHING LURE ASSEMBLY and filed Jan. 22, 2007, now abandoned, which are made part hereof by reference.

### FIELD OF INVENTION

This invention relates generally to weighted, bladed fishing lures, and more particularly to fishing lures that exhibit a substantially straight line construction between a fishing line connection on the forward end and a fishhook or fishhook assembly (e.g. a fishing hook which has bait attached) on the rearward end, such fishing lures being referenced herein as “inline” lures.

### BACKGROUND AND RELATED ART

There are many types of lures designed to attract fish. A fishing lure line connector is disclosed in U.S. Patent Application 2013/0219770 by Inventor, James Ronald Davis (Davis). Davis discloses a fishing line connector having a single width and having a unitary elongated member shaped to form first and second eyelets at each member end. The line connector may be connected to a blade.

A snag-less fishing lure is disclosed in U.S. Patent Application 2013/0047491 by Inventor, James Ronald Davis (Davis). Davis discloses a snag-less bladed lure having a blade that oscillates during retrieval and pitches forward to protect the hook from snagging upon encountering moss or other elements in the water. The fishing lure may include pitching means for pitching the blade relative to the hook. Further, the upper end of the blade oscillates side-to-side relative to a hook connector.

A snag resistant fishing lure is disclosed in U.S. Pat. No. 7,726,062 B2, issued Jun. 1, 2010 to James Ronald Davis (Davis). Davis discloses a jig with an attached blade. The jig has a weight molded about the shank of a hook with an eyelet disposed to maintain the sharpened point of a hook held upright by the relative dispositions of the eyelet, weight and orientation of the point. The blade is taught to be affixed to the eyelet, and to be limited in oscillation by either collision of the blade with the eyelet or with the weight to which it is directly affixed. Further, the blade is taught to comprise three holes, one of which is used to securely affix the blade to the eyelet. The other two holes are taught to be used in cooperation with a clip affixed to a fishing line for the purpose of releasibly affixing the fishing line of a fishing lure unit which comprises both blade and weighted fishing lure.

Wuensch et al., U.S. Pat. No. 8,028,465 B1, teaches a fishing lure and method of assembly comprising a lip, an eyelet extending forward of the lip. The eyelet being adapted to be attached to the fishing line for pulling the fishing lure through the water in a direction of movement towards the lip such that the lip imparts a movement to the fishing lure. Additionally, a buoyant or neutrally buoyant paddle extending from, and rigidly attached to the lip, having opposed side surfaces that together counterbalance the movement imparted by the lip. The invention includes a hook having a shank that is fixedly attached to and extends from the paddle.

Applicant believes that no fishing lure reference, disclosed, is the basis for an inline lure.

### DEFINITIONS

For purposes of this disclosure, the following definitions apply:
aft, adv, near, toward, or in the rear of a lure away from a line of attachment.
blade, n, a broad flattened part which is affixed to a portion of a fishing lure and which oscillates as the lure is propelled in water to provide a wake following therefrom; such a blade may be rigid or flexible, if flexible such a blade requires a supporting mast to withstand pressure from being displaced through water.
centrally, adv, near, toward the center of gravity, syn: medially.
distal, adj, (see also proximal) indicates the segment of a device normally away from a line attachment of a lure.
fishhook, n, a device, usually made of rigid metal wire, comprising at least one curved section and ending with a sharpened point on each curved section for catching a fish and a shank which comprises a substantially straight portion on an opposite end. Generally, the shank is ultimately affixed with an eyelet (hook connector feature) and split ring to the lure or it may be directly and securely affixed to the hook receiver portion of the lure.
fishhook assembly, n, a combination of a fishhook and other optional attributes associated with the fishhook for attaching the fishhook to a frame or frame and for adding attractive components such as an artificial or natural bait.
fore, adv, in, toward or adjacent to the front (i.e. forward) toward a line of attachment.
inferior, adj, situated lower down or closer to the center of the earth than a referenced site.
jig, n, a fishhook which has a weight affixed about an associated shank of the fishhook.
proximal, adj, indicates the segment of a device normally closely disposed relative to a line attachment of a lure.
shank, n, a frame which is a proximal portion of a fishhook the shank usually having a substantially straight portion which is associated with a curved portion of a fishhook and with a connecting link by which the fishhook is affixed to other fishing gear.
substantially, adv: having a similar form and function which does not materially depart from an ideal or perfect form of the referenced item (e.g. a ball may be considered to be substantially spherical while having minor variances which cause it to be imperfect relative to an ideal sphere).
superior, adj, situated higher up or away from the center of the earth relative to a referenced site.
yaw, n: oscillatory angular motion which is disposed about an axis subtending substantially orthogonally behind a blade of a lure.
vertical oscillation: oscillatory angular displacement which is substantially disposed about an axis determined by oscillation about an angle of attack of a blade.

### BRIEF SUMMARY AND OBJECTS OF THE INVENTION

In brief summary, this invention is based upon a novel fishing lure frame for a bladed fishing lure assembly, the frame comprising a substantially straight line construction between a fishing line connection and a trailing fishhook or fishhook assembly. The bladed fishing lure assembly comprises an oscillating blade, a weight and a fishhook or fishhook assembly affixed to the frame. The frame includes a feature for connecting a fishing line at a forward end and a rearwardly disposed portion whereat the weight is securely affixed such that frame motion influences subsequent motion of the weight. The blade is positioned forward relative to the weight such that when drawn through the water, the blade oscillates side-to-side. The frame may include a loosely affixed fishhook rearward of the weight using a split ring or the fishhook be attached directly to the frame. The fishhook may be a treble, single barbed or other suitable hook. The frame may also include a clasp whereby the blade is securely, but releasably affixed thereto. A substantially straight line (inline) frame construction between the fishing line connection and fishhook or fishhook assembly assures the bladed fishing lure assembly is not de-tuned by changes that alter the original manufacturing geometry of the frame due to opposing pulling forces (from a fish or snag).

Lures made according to the instant invention may have as few as four components and include novel frame features for ease of assembly with minimal threading when assembled to a blade designed for oscillation when drawn through water. A weight is attached to the frame substantially inline between a line connection feature and a fishhook or fishhook assembly which is located at the rearward end of the bladed fishing lure. The fishing lure is weed resistant as a result of the substantially inline design. The frame may include a single jointed segment to provide immediate feedback when a fish strikes the hook. The substantially inline frame design minimizes potential stresses to the frame that result in lure frame bending in certain other lures and which require tuning from time to time by the user to re-form the frame back to its manufactured shape. Such a frame may be made from spring tempered stainless steel wire having a slight curvature in the segment near the weight which when stressed to a straightened inline state by opposing forces, returns naturally to its original curvature after forces are removed. Frames having slight curvatures which inherently return from a straightened state, not requiring tuning of the frame following use (such as force applied by a fish or snag) are considered to be within the scope of the instant invention.

Primary to the invention is the interaction of an oscillating blade and the frame to create a lateral side-to-side motion in the weight. The loosely, but securely attached oscillating blade, comes in contact with the frame and having sufficient mass creates a “hammer” effect during each oscillation, the resulting energy of the contact is transferred through the frame that is securely attached to the weight to create a laterally opposing side-to-side rotary motion of the weight.

It is a primary objective to provide a substantially inline bladed fishing lure assembly having a frame shaped to facilitate ease of blade assembly.

Another primary objective is to provide a bladed fishing lure having an exaggerated bait motion relative to the motion of the weight.

An important objective is to provide a bladed fishing lure frame that maintains its original manufactured form after forces are applied by a fish or snag when drawn through water.

Another objective is to provide a weight that moves directly in relation to the side-to-side movement of the oscillating blade.

An important objective is to provide a hooking capability attached rearward of the weight which can be accomplished with an attached split ring and fishhook or a fishhook connector directly attached to a frame fishhook receiver.

It is an important object to provide a blade member that is securely, but pivotally affixed to the frame such that the blade oscillates when displaced through water.

It is a major objective to provide a simplified method for connecting a blade to a frame and for amplified displacement of a fishhook or fishhook assembly due to the oscillation of said blade and placement of the fishhook receiver offset from the weighted lure center of rotation.

It is another important object to provide a frame variance which permits off-line displacement of the fishhook but retracts the fishhook to an inline disposition when affected by opposing pulling forces.

These and other objects and features of the present invention will be apparent from the detailed description taken with reference to accompanying drawings.

### BRIEF DESCRIPTION OF THE DRAWINGS

FIG. 1 is a rearward perspective of the substantially inline weighted lure assembly made according to the present invention.

FIG. 2 is a rearward perspective of the substantially inline weighted lure assembly with an artificial bait attached to a single barbed hook.

FIG. 3 is a rearward perspective of the substantially inline weighted fishing lure showing the line connection, inline frame and hook during retrieval when forces are applied to the hook such as when a fish strikes the lure.

FIG. 4 is a rearward perspective of the substantially inline weighted fishing lure with a hook receiver and clasp at the rearward end of the weighted fishing lure for amplifying hook and bait action and providing an ability to exchange hooks.

FIG. 5 is a rearward perspective of the substantially inline weighted fishing lure with the frame clasp at the rearward end of the weighted fishing lure showing the inline components when a force is applied to the hook such as when a fish strikes the hook.

FIG. 6 is a rearward perspective of the weighted fishing lure with the blade positioned prior to assembly to frame including a forward clasp for securing the blade to the frame.

FIG. 7 is a rearward perspective of the weighted fishing lure with the blade partially assembled on the frame.

FIG. 8 is a side perspective of the weighted fishing lure with the blade fully assembled to the frame.

FIG. 9 is a frontal view showing the blade attached to the frame and the clasp securely positioned to secure the frame to the blade.

FIG. 10 is a rearward perspective of the weighted fishing lure with a different version of the frame with dashed arrows showing the direction of assembly of the blade to the frame.

FIG. 11 is a side view of the blade, frame and weight assembly with the blade fully assembled to the frame having a forward frame portion bent to a position to hold the blade on the frame.

FIG. 12 is a rearward perspective of a blade (having only one hole), and an optional version of the frame with the blade positioned for assembly to the frame (hook assembly not shown).

FIG. 13 is a frontal view of the substantially inline fishhook fishing lure with the blade assembled to the frame and a securement ring to secure the blade to the frame.

FIG. 14 is a frontal view of the weighted fishing lure with the blade oscillating as noted by an arrowed line.

FIG. 15 is a top view of the bladed fishing lure according to the instant invention showing the fishhook in line with the frame (but not including a bait portion that may be attached to the fishhook assembly).

FIG. 16 is a top view of the bladed fishing lure made according to the present invention showing angular rotation of the bladed fishing lure (including a bait portion) in dashed lines and arrowed lines to indicate movement of the frame, blade, weight, fishhook and bait as the inline bladed fishing lure is drawn through water.

These and other objects and features of the present invention will be apparent from the detailed description taken with reference to accompanying drawings.

### DETAILED DESCRIPTION OF THE ILLUSTRATED EMBODIMENTS

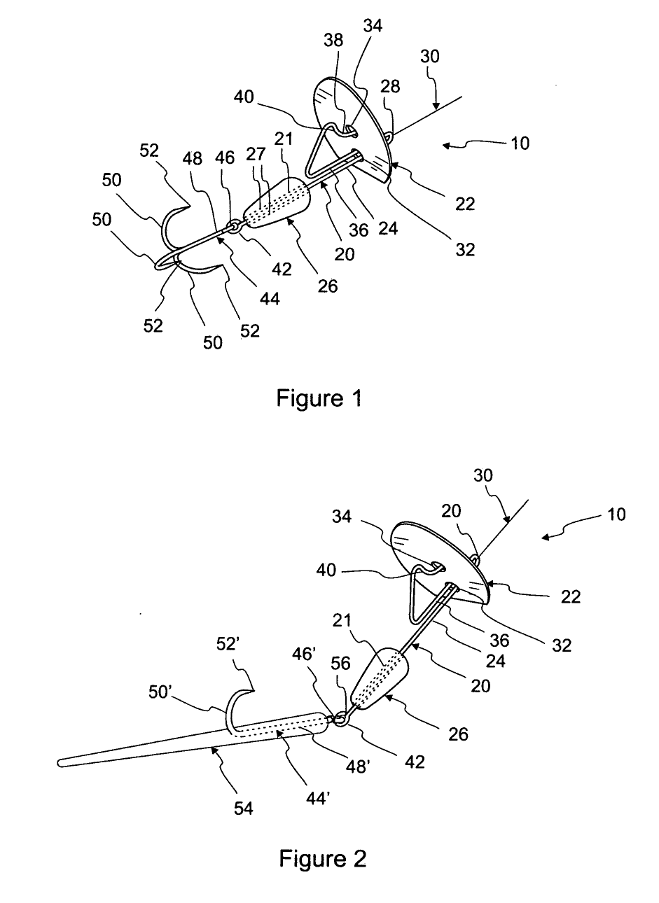

Reference is now made to the embodiments illustrated in FIG. 1-16 wherein like numerals are used to designate like parts throughout. Primes of numbers designate labeled lure parts which are similar in form and function, but not identical, to parts numbered without primes.

Reference is now made to FIG. 1, wherein an inline bladed fishing lure assembly 10 made according to the instant invention is seen and is currently the preferred embodiment. Assembly 10 comprises a frame 20 which may be manufactured using stainless steel wire. Frame 20 has an attached blade 22 that is loosely, but securely attached to frame 20 such that it oscillates when drawn through water having a substantially vertical orientation. Blade 22 may be made of metal such as stainless steel, brass, plastic or other suitable materials that oscillate about a wire form when drawn through water. Assembly 10 also comprises an inferiorly directed straight, frame segment 24 to which weight 26 is preferably slidably, but securely affixed. Weight 26 also includes an inner lumen 21, indicated by dashed lines (commonly numbered 27) disposed about segment 24. Weight 26 may be made of metal such as lead alloy, tungsten, brass and tin/bismuth to be a ballast for assembly 10. Other metals may also be used in forming weight 26 that have sufficient mass to act as ballast for assembly 10. Frame 20 comprises a forward bend 28 for attaching a fishing line 30. Blade 22 comprises a medially disposed inferior hole 32 through which segment 24 is displaced. While segment 24 appears to be straight, it may be only substantially straight having a slight curvature when formed using spring tempered stainless steel which inherently returns to an original state after being stressed to an inline state by opposing forces. Following such opposing forces, frame 20 returns to its original manufactured geometry and therefore, does not require tuning by the user. Frame 20 is also seen to comprise a frame segment 36 that passes through inferior hole 32. A frame segment 38 passes through a superior hole 34 of blade 22. Frame 20 may have a superiorly directed segment 40 rearward of blade 22 for orienting blade 22 to oscillate when drawn through water. Inferiorly directed frame segment 24 passes through weight 26 to a rearward fishhook receiver 42 for securing fishhook 44 at fishhook connector 46 to frame 20. Fishhook 44 also includes a shank 48 and three fishhook bends, each commonly numbered 50, with each fishhook bend terminating in sharpened end 52. As one skilled in fishing arts well understands, tugs on fishhook 44 or weight 26 will not tend to de-tune (bend frame 20 from originally manufactured form) or likewise substantially change operating characteristics of assembly 10 or other substantially inline embodiments disclosed hereafter. It is noted that fishhook connector 46 and fishhook receiver 42 create a single joint along the substantially inline frame 20 to provide instantaneous feedback when a fish strikes the bladed fishing lure.

Reference is now made to FIG. 2, wherein a substantially inline bladed fishing lure assembly 10 has substantially inline frame 20, blade 22 and weight 26 however, the associated fishhook 44 shows a single barbed hook 44′ having a fishhook connector 46′ assembled to fishhook receiver 42. Fishhook 44′ has a shank 48′ and a fishhook bend 50′ terminating in a hook sharpened point 52′. Fishhook 44′ may have an associated bait 54 (natural or artificial) that has a swimming or fish-like motion resulting from blade 22 oscillation and resulting influence on frame 20 when drawn through water. Fishhook receiver 42 may have tag end 56 wrapped about frame 20 rearward of weight 26 to secure fishhook 44′ securely (not shown). The fishing lure may be manufactured in various sizes, colors and weights to meet the requirements of catching a variety of fish.

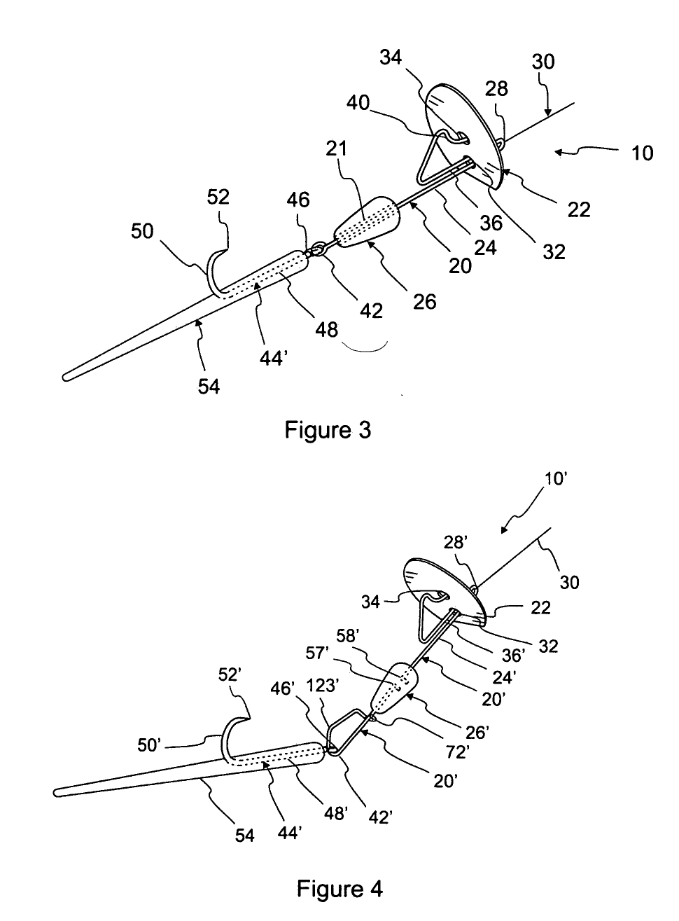

Reference is made to FIG. 3, wherein an inline bladed fishing lure assembly 10 is shown with identical elements in FIG. 2, but with fishhook 44′ substantially in line with weight 26, blade 22 and frame 20 to demonstrate the substantially inline configuration assembly 10 assumes when a fish is hooked to the bladed fishing lure assembly 10. The substantially inline orientation of bladed fishing lure assembly 10 provides inhibition to excessive bending of frame 20 which significantly reduces the need to “tune” frame 20 to original manufacturing geometry.

Reference is now made to FIG. 4 wherein a bladed fishing lure assembly 10′ is shown with frame 20′ having a rearward bend 123′ associated with a clasp 72′ allowing the user to change fishhook 44′ to varying fishhook styles (not shown) for attaching a bait 54 (may be natural or artificial). Wire clasps, such as clasp 72′, are well known to those skilled in the art. Bladed fishing lure assembly 10′ may be manufactured with a single wire form however, single wire forms may become interconnected during manufacture and be difficult to separate. For this reason, it is considered prudent to manufacture a second, separate wire form for affixing bladed fishing lure assembly 10′ rearward of weight 26′. In the case where two wire forms are utilized, wire form bends 57′ and 58′ demonstrate how each may be held securely within weight 26′.

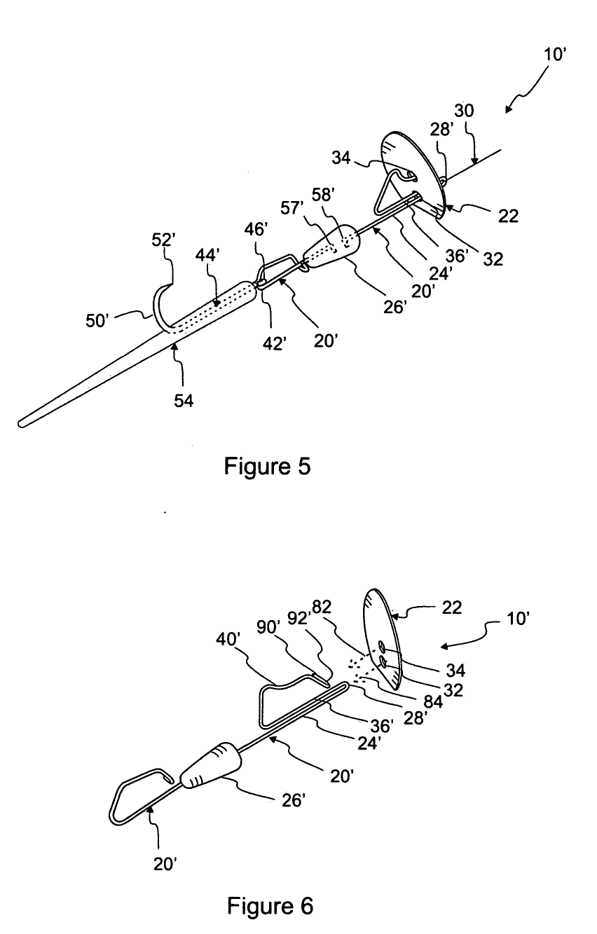

FIG. 5 shows a substantially inline bladed fishing lure assembly 10′ with frame 20′, blade 22, weight 26′ and hook 44′ positioned in line when the force of fish is applied to the lure. The substantially inline nature of bladed fishing lure assembly 10′ when reeling in a fish maintains the integrity of frame 20′ by having only one moveable joint between fishhook 44′ and fishhook connector 46′.

Reference is now made to FIG. 6 wherein the direction of assembly of blade 22 is shown by dashed arrows 82 and 84. Note that bend 28′ is directed through blade hole 32 and tag end 90′ and clasp 92′ is directed through blade hole 34.

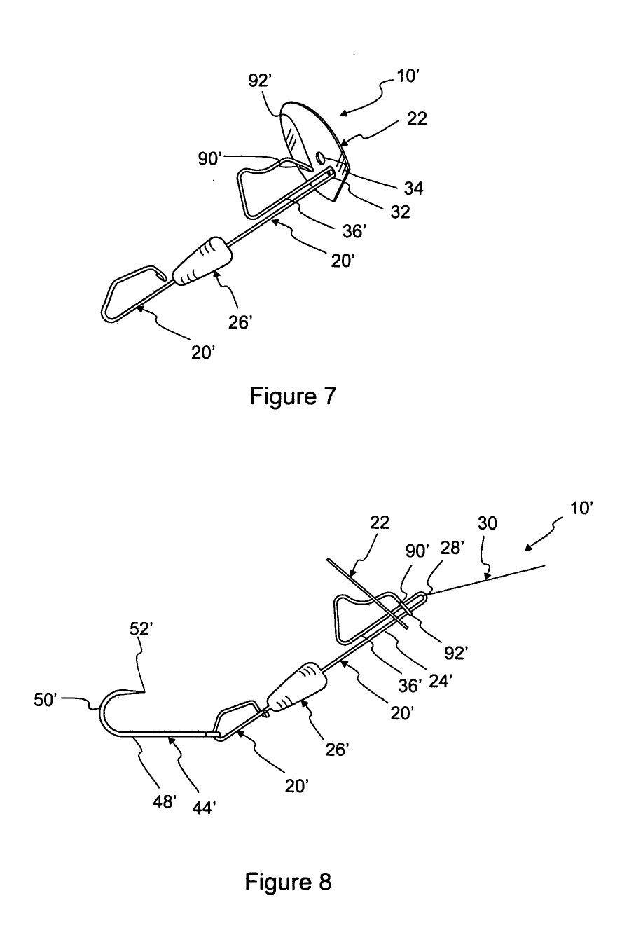

Reference is now made to FIG. 7 wherein frame 20′ is partially assembled through blade hole 32 of blade 22. A tag end 90′ and a clasp 92′ are positioned for placement through blade hole 34 as shown. (Note: FIG. 7 is shown without a fishhook assembly on the rearward wire form although at least a fishhook is required to complete the bladed fishing lure assembly). A facile assembly of blade 22 to frame 20′ is accomplished by displacing tag end 90′ through hole 34 as seen completed in FIG. 8.

As shown in FIG. 8, blade 22 is fully assembled on the bladed fishing lure assembly 10′. Clasp 92′ is securely positioned about inferior frame segment 24′ forward of blade 22.

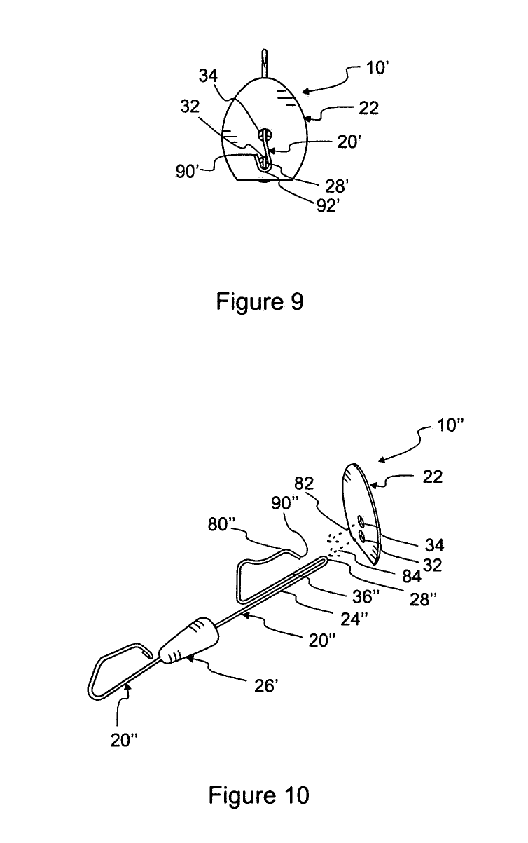

FIG. 9 shows a frontal view with clasp 92′ secured to frame segments 24′ and 36′ (see FIG. 8) to loosely, but securely maintain blade 22 to frame 20′.

Reference is now made to FIG. 10 wherein frame 20″ is manufactured of wire such as hardened wire similar to that used in fishhooks to generally retain their shape, although not hardened to the extent that minor bends are impractical in lure construction. Blade 22 is attached to frame 20″ in a similar manner as in FIG. 6 however a clasp 92′ (see FIG. 9) is not required in order to retain blade 22 in place. Frame bend 28″ is placed through inferior blade hole 32 first and then tag end 90″ is inserted through superior blade hole 34 and is then bent inferiorly to loosely, but securely attach blade 22 to frame 20″. Frame 20″ may have a slight curvature that, being manufactured of hardened wire superior to weight 26′ and spring tempered stainless steel wire inferior to weight 26′.

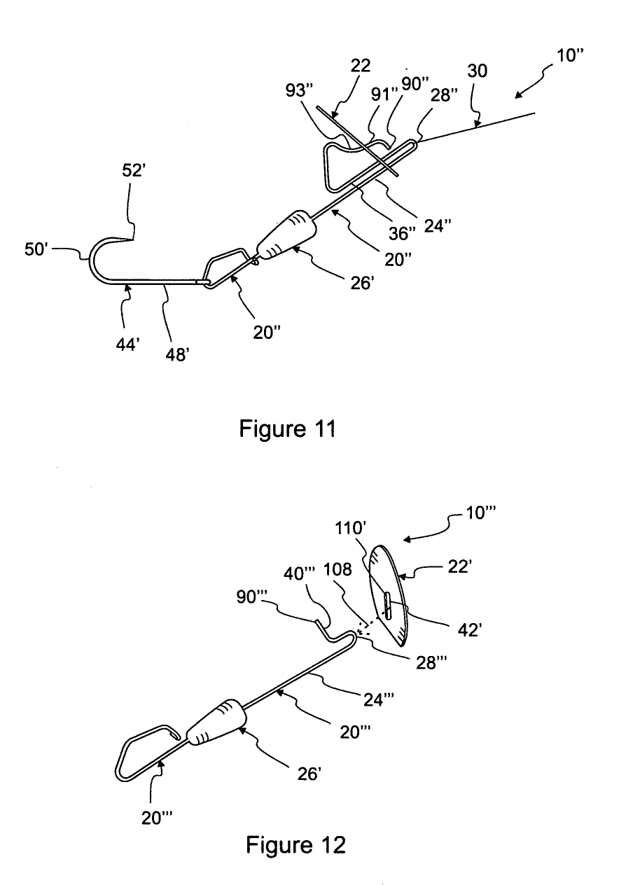

As shown in FIG. 11, frame bend 28″ is positioned through blade inferior hole 32 and frame tag end 90″ and frame segment 93″ is positioned through blade superior hole 34 with frame segment 91″ bent inferiorly into close proximity to superior frame segment 36″ to secure blade 22 to frame 20″.

FIG. 12 shows a simplified frame 20′″ having a frame bend 28′″ and a superior extending mast 40′″ ending in a tag end 90′″ which is attached to blade 22′ through a single blade hole 110′ as indicated by dashed arrow 108. Extending mast 40′″ supports blade 22′ during oscillation through water. Frame 20″ may be manufactured of hardened wire or stamped steel (not shown in the Figures, but is well known to one who is skilled in the art).

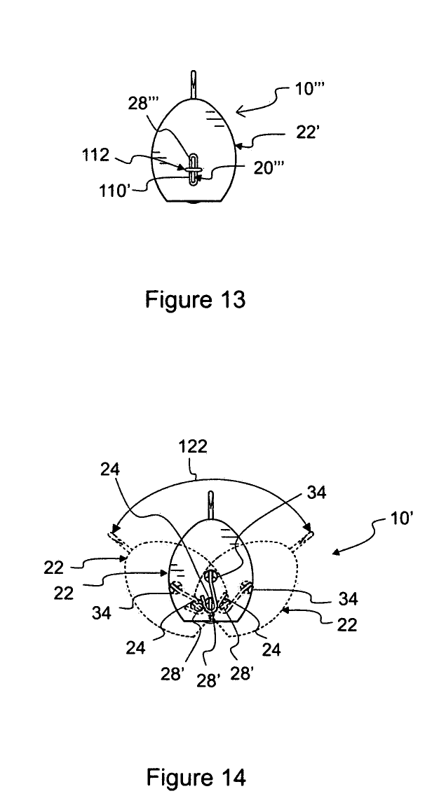

FIG. 13 shows frame bend 28′″ in position through blade hole 110′ in blade 22′. A retaining ring 112 is fastened to frame bend 28′″ to retain frame 20′″ through blade 22′. A line or wire clip may be connected to ring 112 (line or wire clip not shown).

As seen in FIG. 14, lure motion when drawn through water is dependent upon at least side-to-side motion of blade 22 oscillation substantially about a weight (such as weight 26′, see FIGS. 1-5 and segment 24 or 24′). Another, and separate mode of motion substantially orthogonal to the side-to-side motion may also be present, but is not further disclosed herein. For purposes of understanding blade motion and motion transfer attention is drawn to side to side action or yaw noted by arrowed line 122. The side-to-side motion creates a like motion at bend 123′ (see FIG. 4). It should be noted that such motion can displace fishhook connector 46′ toward bend 123′ which adds additional displacement motion to a fishhook assembly as noted by fishhook 44′ and bait 54. Note also that a pulling force on hook 44′ further displaces connector 46′ back to fishhook receiver 42′ substantially in line with forward bend 28′.

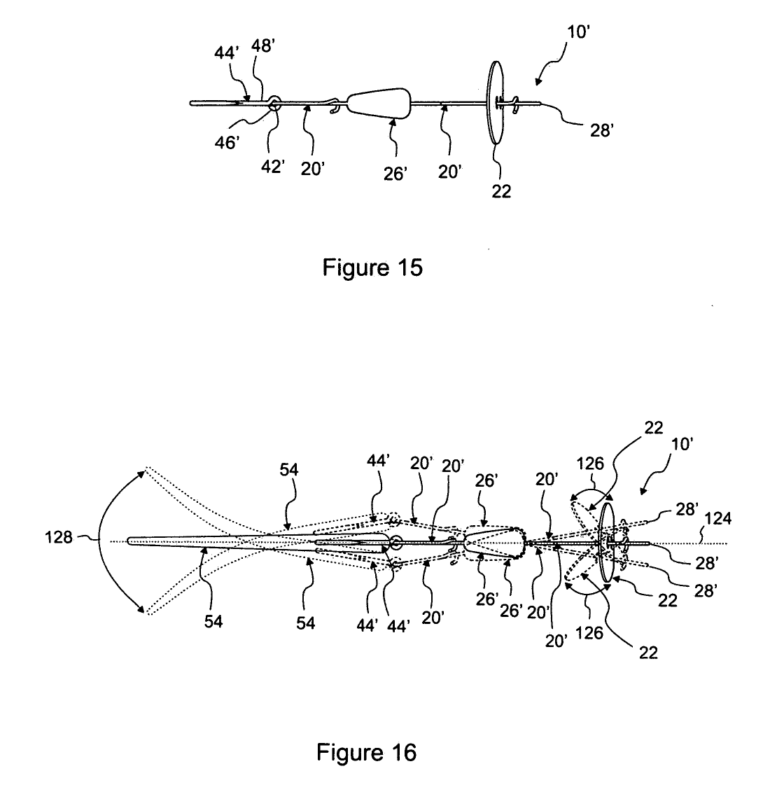

Reference is now made to FIGS. 15 and 16. In FIG. 15, the instant invention is shown in a top view (natural or artificial bait is not shown in FIG. 15, but seen in FIG. 16). As seen in FIG. 16, inline bladed fishing lure assembly 10′ is seen in three sites of oscillation about a central axis 124. Angular motion as referenced by arrowed line 128 produces side-to-side displacement which is linearly communicated to rear lure parts. Blade 22 rotation as noted by arrowed line 126 and resulting contact with frame 20′ produces bladed fishing lure angular rotation with fishhook 44′ angled to influence bait 54 motion when drawn through water.

The present embodiment should be considered in all respects as illustrative and not restrictive, the scope of the invention being indicated by the appended claims rather than by the forgoing description, and all changes which come within the meaning and range of equivalency of the claims are therefore intended to be embraced herein.

What is claimed and desired to be secured by Letters of Patent is:

1. A bladed fishing lure having a substantially straight line of communication between opposing pulling forces applied to a fishing line connecting site and a fishhook such that there is no de-tuning bending moment imposed upon the force communicating frame part resulting from application of the opposing forces, said lure comprising:
a fishing lure frame comprising a plurality of bends and substantially straight segments between said bends to thereby provide (1) a lure blade stabilizer which determines angle of attach of a lure blade when displaced through water, (2) segments which are displaced through the blade to securely, but loosely affix the blade to the frame, (3) a bend site forward of the blade where a fishing line is affixed, (4) a substantially straight section aft of the fishing line connecting site comprising a site where a weight is affixed disparate from the blade and continuing therefrom to a fishhook attachment site and (5) the fishhook attachment site which provides a connection for the fishhook which is free to exhibit rotary and side to side oscillation imposed by yaw and vertical oscillation of the blade;
a blade formed and shaped to yaw and vertically oscillate when drawn through the water affixed to said frame, said blade further comprising hole structure through which the frame segments are displaced to affix said blade to said frame; and
a weight disposed along the substantially straight section aft and disparate from the blade and forward of said fishhook to provide stabilizing ballast for said lure while being displaced side-to-side by action of said blade.

2. A bladed fishing lure according to claim 1 comprising a frame comprising a single continuous wire.

3. A bladed fishing lure according to claim 1 comprising a frame comprising two wire parts linearly joined by a securely affixed weight to form the substantially straight section.

4. A bladed fishing lure according to claim 1 comprising a fishing lure frame further comprising an upwardly disposed shaft for the blade stabilizer.

5. A bladed fishing lure according to claim 1 comprising a blade comprising two holes whereby the blade is affixed to the frame and one of the two holes through which the straight section is displaced to communicate with the weight and fishhook attachment site.

6. A bladed fishing lure according to claim 1 comprising a weight further comprising an elongated frustoconical shape with an aft disposed diminished dimension.

7. A bladed fishing lure according to claim 1 comprising a weight comprising shape and dimensions of a fish.

8. A bladed fishing lure according to claim 1 comprising a frame comprising a plurality of bends whereby buoyancy of an associated fishhook assembly causes the associated fishhook assembly to be resultingly displaced upward into improved communication with turbulence associated with wake of said blade when free of pulling force upon an associated fishhook assembly and displaced to be substantially in line with the straight section resulting from a pull force applied to the fishhook.

9. A bladed fishing lure according to claim 1 comprising an associated fishhook comprising a single treble hook.

10. A bladed fishing lure according to claim 1 comprising a fishhook assembly to frame connection comprising a releasable clasp.

11. A bladed fishing lure according to claim 1 comprising a frame comprising blade affixing segments which comprise a releasable clasp.

12. A bladed fishing lure according to claim 1 comprising an affixed fishhook assembly comprising a fishhook and bait.
